(19) United States
(12) Patent Application Publication
(10) Pub. No.: US 2017/0197344 A1
(43) Pub. Date: Jul. 13, 2017

(54) METHOD FOR MAKING HOUSING

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHANG-HAI GU, Shenzhen (CN); XIAO-KAI LIU, Shenzhen (CN); YAO-YAO QIN, Shenzhen (CN)

(21) Appl. No.: 15/472,303

(22) Filed: Mar. 29, 2017

Related U.S. Application Data
(62) Division of application No. 14/556,658, filed on Dec. 1, 2014.

(30) Foreign Application Priority Data
Feb. 26, 2014 (CN) 201410065545.0

(51) Int. Cl. B29C 45/14; C23F 1/02

(52) U.S. Cl. CPC B29C 45/14311; C23F 1/02; B29C 2045/14327; B29C 2045/14868; B29K 2075/00

(57) ABSTRACT

A method of making a housing includes: providing a preliminary housing; forming a plurality of through gaps on the sections of a portion of the preliminary housing by laser cutting technology, remaining sections of the preliminary housing are spaced by the through gaps and form a plurality of metal sheets and the at least one main portion, the metal sheets and the main portion are spaced from each other by the gaps; and forming a plurality of spacers by filling liquid resin composition into the through gaps existing between the at least one main portion and the adjacent metal sheets, and the through gaps between the two adjacent metal sheets, the spacers, the metal sheets, and the main portion constitute a base.

### CROSS-REFERENCE TO RELATED APPLICATIONS

This application is a division application of U.S. patent application entitled “HOUSING, ELECTRONIC DEVICE USING SAME, AND METHOD FOR MAKING SAME” with application Ser. No. 14/556,658, filed on Dec. 1, 2014 and having the same assignee as the instant application.

This application claims priority to Chinese Patent Application No. 201410065545.0 filed on Feb. 26, 2014, and claims priority to U.S. patent application Ser. No. 14/556,658, filed on Dec. 1, 2014, the contents of which are incorporated by reference herein.

### FIELD

The subject matter herein generally relates to a housing and an electronic device using the housing.

### BACKGROUND

Metal housings are widely used for electronic devices.

### BRIEF DESCRIPTION OF THE FIGURES

Implementations of the present technology will now be described, by way of example only, with reference to the attached figures.

FIG. 1 is an isometric view of an electronic device, according to an exemplary embodiment.

FIG. 2 is an isometric view of a housing of the electronic device shown in FIG. 1.

FIG. 3 is an exploded, isometric view of the housing shown in FIG. 2.

FIG. 4 is a cross-sectional view of the housing along line IV-IV of FIG. 2.

### DETAILED DESCRIPTION

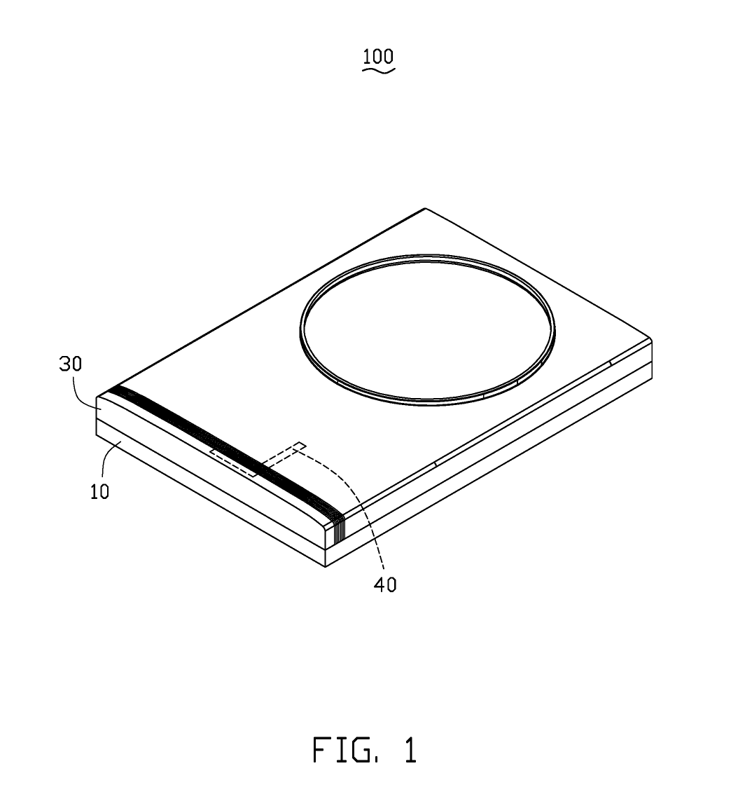

FIG. 1 illustrates an electronic device 100 according to an exemplary embodiment. The electronic device 100 can be, but not limited to being, a mobile phone, a personal digital assistant or a panel computer. The electronic device 100 includes a main body 10, a housing 30 assembled to the main body 10, and an antenna 40 located inside the housing 30.

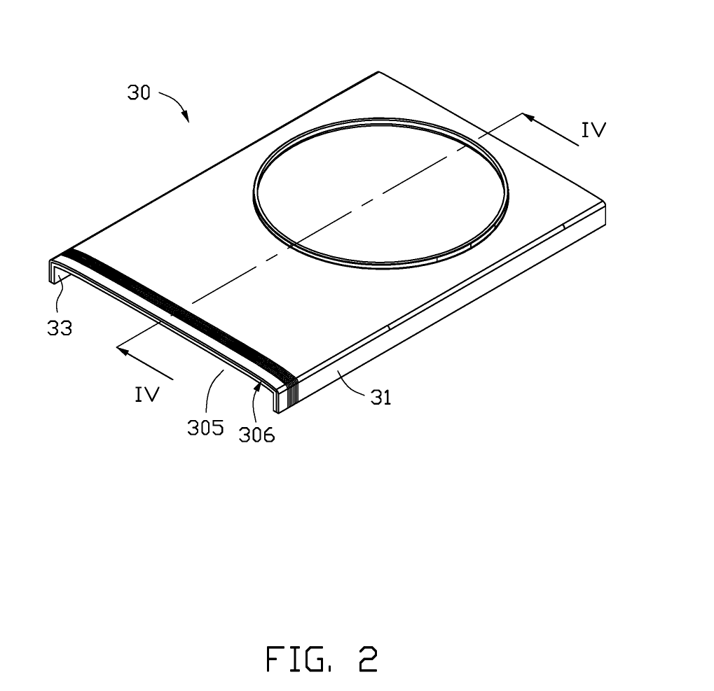

Referring to FIGS. 1-2, in one exemplary embodiment, the housing 30 can be a back cover of the electronic device 100. The housing 30 includes a base 31 and a reinforcement layer 33 attached to an internal surface 306 of the base 31. The base 31 further includes a receiving space 305 cooperating with main body 10 to receive internal elements of the electronic device 100, such as the antenna 40, battery (not shown) and so on.

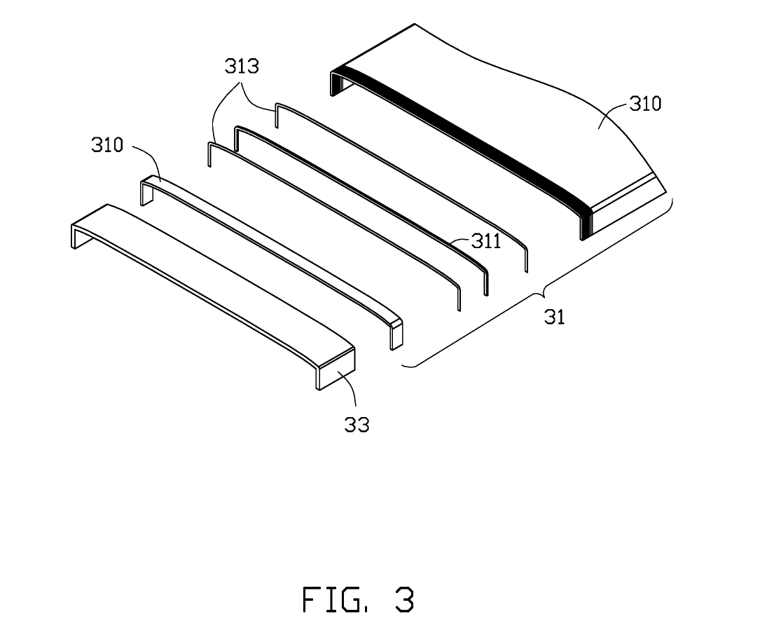

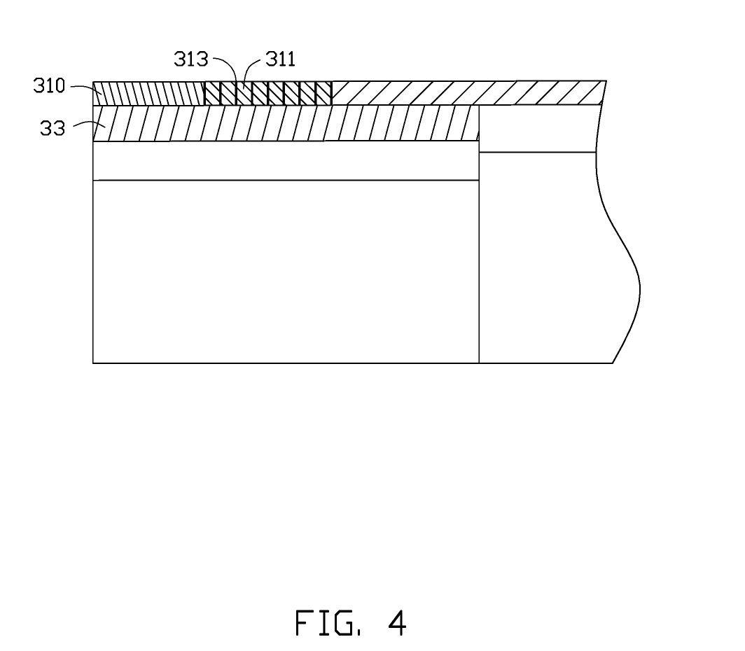

Referring to FIGS. 1 and 3-4, the base 31 is three-dimensionally shaped. In one exemplary embodiment, the base 31 is substantially U-shaped. The base 31 includes at least one main portion 310, a plurality of metal sheets 311 and a plurality of non-conductive spacers 313. In one exemplary embodiment, the base 31 includes two main portions 310. The main portions 310 and the metal sheets 311 are made of metal. The metal can be selected from a group consisting of aluminum alloy, titanium alloy, magnesium alloy, and stainless steel. The metal sheets 311 and the spacers 313 are sandwiched between the two main portions 310, and each metal sheet 311 alternates with one spacer 313. Each two adjacent metal sheets 311 are connected to each other by one spacer 313 located between the two metal sheets 311. A spacer 313 is entirely positioned between each main portion 310 and a metal sheet 311 adjacent to the main portion 310, thereby combining the main portions 310 with the metal sheets 311 adjacent to the main portions 310 together. The spacers 313 are made of dielectric resin composition, such as a polyurethane ultraviolet curing resin composition. The spacers 313 can also be made of anodic oxide film, such as anodic alumina film, anodic titanium oxide film, or anodic magnesium oxide film. The main portions 310 and the metal sheets 311 are electrically isolated with each other. That is, a spacer 313 is entirely filled within each main portion 310 and a metal sheet 311 adjacent to the main portion 310, thereby the main portions 310 is disconnected from the metal sheets 311 adjacent to the main portions 310 together. In addition, each two adjacent metal sheets 311 are electrically isolated to each other by one spacer 313 located between the two metal sheets 311. Each metal sheet 311 has a thickness of 0.4 mm to 1.0 mm along a direction from an adjacent spacer 313 located at one sided of the metal sheet 311 to another adjacent metal sheet 311 located at an opposite side of the metal sheet 311. Each spacer 313 has a thickness of 20 μm to 60 μm along a direction from an adjacent spacer 313 located at one sided of the metal sheet 311 to another adjacent metal sheet 311 located at an opposite side of the metal sheet 311, thereby creating a distance between each main portion 310 and the adjacent metal sheet 311 of 20 μm to 60 μm, and creating a distance between each two adjacent metal sheets 311 of 20 μm to 60 μm. The thickness of each spacer 313 can also be 0.01 mm to 0.1 mm along a direction from an adjacent spacer 313 located at one sided of the metal sheet 311 to another adjacent metal sheet 311 located at an opposite side of the metal sheet 311, thereby creating a distance between each main portion 310 and the adjacent metal sheet 311 of 0.01 mm to 0.1 mm, and creating a distance between each two adjacent metal sheets 311 of 0.01 mm to 0.1 mm. Said distances are corresponding to the antenna 40. The metal sheets 311 are substantially U-shaped. Each spacer 313 is adhered to adjacent metal sheets 311. Each spacer 313 is also substantially U-shaped to engage with the shape of the metal sheets 311. The spacers 313 are also U-shaped.

The base 31 includes the internal surface 306 facing the receiving space 305.

The reinforcement layer 33 is formed on the internal surface 306. The reinforcement layer 33 covers the metal sheets 311 and the spacers 313, and entirely or partially covers an end portion of the main portion 310 connected to the spacers 313. As such, the main portion 310, the metal sheets 311, and the spacers 313 are bonded together through the reinforcement layer 33. The reinforcement layer 33 can further enhance a bonding strength among the main portion 310, the metal sheets 311 and the spacers 313 respectively. The reinforcement layer 33 is made of resin selected one or more from a group consisting of polyphenylene sulfide (PPS), polybutylene terephthalate (PBT), nylon (PA), polyethylene terephthalate (PET), polytrimethylene terephthalate (PTT), Polyetherimide (PEI), polyether ether ketone (PEEK), poly(ethylene-co-1,4-cyclohexylenedimethylene terephthalate) (PCT), and their modified materials.

When the housing 30 is mounted to the main body 10, a portion of the housing 30 made up of the metal sheets 311 and the spacers 313 are aligned with the antenna 40.

An exemplary method for making the housing 30 can include the following steps.

A preliminary housing (not shown) having a desired three-dimensional shape of the housing 30 is provided. The preliminary housing can be made by casting, punching, or computer number control.

Sections of a portion of the preliminary housing corresponding to the antenna 40 are cut off by laser cutting technology, thereby forming a plurality of gaps (not shown). Remaining sections of the preliminary housing are spaced by the gaps and form the plurality of metal sheets 311 and the at least one main portion 310. In at least one embodiment, the gaps are through gaps, and the preliminary housing divided into a plurality of metal sheets 311 and two main portions 310 by the through gaps. In another embodiment, the gaps are positioned wholly within the preliminary housing, and the preliminary housing divided into a plurality of metal sheets 311 and a main portion 310 by the gaps.

The main portion 310 and the metal sheets 311 are arranged to be aligned with each other. Each main portion 310 and the adjacent metal sheet 311 are spaced from each other by the through gaps, each two adjacent metal sheets 311 are also spaced from each other by the through gaps. Liquid resin composition is filled into the through gaps existing between each main portion 310 and the adjacent metal sheet 311, and the through gaps between each two adjacent metal sheets 311. That is, the through gaps are entirely filled with the resin composition. The resin composition is then solidified to form the spacers 313 by UV irradiation at room temperature. The thickness of each spacer 313 is 20 μm to 60 μm along a direction from an adjacent spacer 313 located at one side of metal sheet 311 to another adjacent metal sheet 311 located at an opposite side of the metal sheet 311. The spacers 313, the metal sheets 311, and the main portion 310 constitute the base 31. The base 31 is three-dimensionally shaped, and has the receiving space 305. In this exemplary embodiment, the main portions 310 and the metal sheets 311 are electrically isolated with each other. That is, a spacer 313 is filled within each main portion 310 and a metal sheet 311 adjacent to the main portion 310, thereby the main portions 310 is disconnected from the metal sheets 311 adjacent to the main portions 310 together. In addition, each two adjacent metal sheets 311 are electrically isolated to each other by one spacer 313 located between the two metal sheets 311.

The reinforcement layer 33 is formed on the internal surface 306. The reinforcement layer 33 covers the metal sheets 311 and the spacers 313, and totally or partly covers an end of the main portion 310 connected with the spacers 313 to enhance the bonding strength among the main portion 310, the metal sheets 311, and the spacers 313 respectively. The reinforcement layer 33 can be made of plastic.

The reinforcement layer 33 can be formed by the following two methods:

In a first method, a plurality of small holes (not shown) is formed on the base 31 by chemical etching or electrochemical etching. The diameter of holes is 15 μm to 100 μm. Then, molten resin is injected on the internal surface 306 and flows through the holes and by an injection molding process to form the reinforcement layer 33 attached to the internal surface 306 of the base 31 and embedded in the holes.

In a second method, a thermosetting resin adhesive is coated on the internal surface 306 of the base 31, and the thermosetting resin adhesive is naturally dried or dried by heating to form an adhesive layer. The reinforcement layer 33 is then formed on the adhesive layer by injection. The thermosetting resin adhesive can enhance a bonding strength between the metallic base 31 and plastic reinforcement layer 33 respectively.

In another exemplary embodiment, a method for making the housing 30 may include the following steps.

At least one main portion 310 which can be made by casting, punching, or computer number control is provided. When a number of the main portion 310 is more than one. A notch between the main portions 310 is retained corresponding to the antenna 40. A plurality of small holes is formed on the main body 310 by chemical etching or electrochemical etching. The diameter of the small holes is 15 μm to 100 μm.

The plurality of metal sheets 311, which can be made by punching, is provided. The metal sheets 311 can be positioned in the notch. A plurality of non-conductive spacers 313 is formed between the main portion 310 and the adjacent metal sheet 313, and between each two adjacent metal sheets 311 by anodic oxidation or coating non-conductive resin composition on the lateral side of the metal sheets 311. The thickness of each spacer 313 is 0.01 mm to 0.1 mm along a direction from an adjacent spacer 313 located at one side of metal sheet 311 to another adjacent metal sheet 311 located at an opposite side of the metal sheet 311. A plurality of micropores (not shown) is formed on each lateral side of the metal sheets 311. The plurality of micropores on metal sheets 311 correspond to the plurality of micropores on adjacent metal sheets 311.

Liquid plastic composition is filled into the small holes existing on the main body 310 and micropores existing on metal sheets 311, and coated on the internal surface 306 of the base body 31 by insert molding technology to combine the metal sheets 311 and the main body 310 together. The plastic composition is then dried to form the reinforcement layer 33. The spacers 313, the metal sheets 311 and the main body 310 constitute the base body 31. The reinforcement layer 33 covers the internal surface 306 of the base body 31. In other words, the reinforcement layer 33 covers the lateral surface of the main body 310, the metal sheets 311 and the spacers 313. Then the superfluous plastic can be removed by the electric discharge machines. Finally the housing 30 can be polished or decorated.

The metal sheets 311 are spaced from each other by the non-conductive spacers 313. The metal sheets 311 are connected to each other by the spacer layer 313, and the reinforcement layer 33 further enhances the bonding strength among the main portion 310, the metal sheets 311 and the spacers 313 respectively.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A method of making a housing comprising:
providing a preliminary housing;
forming a plurality of through gaps on the sections of a portion of the preliminary housing by laser cutting technology, remaining sections of the preliminary housing are spaced by the through gaps and form a plurality of metal sheets and the at least one main portion, the metal sheets and the main portion are spaced from each other by the gaps; and
forming a plurality of spacers by filling liquid resin composition into the through gaps existing between the at least one main portion and the adjacent metal sheets, and the through gaps between the two adjacent metal sheets, the spacers, the metal sheets, and the main portion constitute a base.

2. The method as claimed in claim 2, wherein a plurality of small holes on the base are formed by chemical etching or electrochemical etching, then a reinforcement layer is formed at an internal surface of the base by injecting molten resin into the small holes by the injection molding process, and the diameter of each of the plurality of small holes is 15 μm to 100 μm.

3. The method as claimed in claim 1, wherein a thermosetting resin adhesive is coated on an internal surface of the base, the thermosetting resin adhesive is naturally dried or dried by heating to forming an adhesive layer, and a reinforcement layer is then formed on the adhesive layer by injection.

4. A method of making a housing comprising:
providing a main portion, the main portion reserves a notch;
providing a plurality of metal sheets, locating the metal sheets in the notch; and
forming a plurality of spacers between the main portion and the adjacent metal sheet, and between each two adjacent metal sheets, the metal sheets and the main portion are connected by the spacers.

5. The method as claimed in claim 4, wherein forming a plurality small holes on the base by chemical etching or electrochemical etching, the diameter of the holes is 15 μm to 100 μm, the thickness of each spacer is 0.01 mm to 0.1 mm along a direction from an adjacent spacer located at one side of metal sheet to another adjacent metal sheet located at an opposite side of the metal sheet.

6. The method as claimed in claim 5, wherein a plurality of micropores is formed on each lateral side of the metal sheets, liquid plastic composition is filled into the holes existing on the main body and micropores existing on metal sheets, and is coated on an internal surface of the metal sheets and the main body by insert molding technology to combine the metal sheets and the main body together, the plastic composition is then dried to form a reinforcement layer.

7. The method as claimed in claim 4, wherein forming the spacers by anodic oxidation or coating non-conductive resin composition on the two opposite lateral sides of the metal sheets.

8. The method as claimed in claim 4, wherein the spacers are coated boards, the coated boards include the spacers formed at the two opposite lateral sides of the metal sheets.
